(19) United States
(12) Patent Application Publication
(10) Pub. No.: US 2003/0145083 A1
(43) Pub. Date: Jul. 31, 2003

(54) System and method for improving support for information technology through collecting, diagnosing and reporting configuration, metric, and event information

(76) Inventors: Michael C. Cush, Lewis Center, OH (US); Gregory S. Spiegelberg, Hilliard, OH (US)

Correspondence Address: PORTER WRIGHT MORRIS & ARTHUR, LLP, INTELLECTUAL PROPERTY GROUP, 41 SOUTH HIGH STREET, 28TH FLOOR, COLUMBUS, OH, 43215

(21) Appl. No.: 10/295,591

(22) Filed: Nov. 15, 2002

Related U.S. Application Data
(60) Provisional application No. 60/332,761, filed on Nov. 16, 2001.

(51) Int. Cl. G06F 15/173

(52) U.S. Cl. 709/224

(57) ABSTRACT

A system for diagnosing an information technology includes a collector server which stores configuration and event information gathered from the information technology environment and formats the information into formatted data. A data warehouse is in communication with the collector server and houses formatted data imported from the collection server. A portal server is in communication with the collector server and the data warehouse and has an interface from which the formatted data in the data warehouse can be viewed. In a service model, the collector server is located at a user site of the information technology while the data warehouse and portal server are located at a provider site remote from the user site. In a stand alone product model, the collector server, the data warehouse, and the portal server are all located at the user site.

### CROSS-REFERENCE TO RELATED APPLICATIONS

This application claims the benefit of U.S. provisional patent application No. 60/332,761 filed on Nov. 16, 2001, the disclosure of which is expressly incorporated herein in its entirety by reference.

### FIELD OF THE INVENTION

The present invention generally relates to systems and methods for identifying and mitigating problems related to computer system, software, hardware, application or device configuration issues that cause downtime.

### BACKGROUND OF THE INVENTION

Independent solution providers provide complex solutions for problems of information technology users in all types of information technology infrastructures. For example, one type of information technology infrastructure is storage environments. An independent complex storage solution provider can provide enterprise data availability solutions including:(1) Disaster Recovery (backup and recovery and/or replication); Online storage (Storage Area Networking [SAN] and Network Attached Storage [NAS]); Application Availability via Clustering Technologies; and Storage Management Software. The solution providers typically develop solutions that encompass technology from several to many different vendors on many different open system platforms such as, for example, Windows NT/2000, Solaris, HP-UX, AIX, Linux, Tru64, and Novell. Once a customer is provided with a working solution, it is common to receive a complaint months later that the solution is no longer working. The largest problem is that in a complex solution with many components supported by many different vendors it is easy to start the finger pointing game. Without a complete picture, it is easy for one vendor to point to another vendor and blame the problem on its technology. To determine why the solution is no longer working, the first question is “What changed?” Finding the answer to this question is often not as easy as it would seem. Typical responses are: customer did not change anything; customer not sure what changed because there are many people administering the system; customer does not want to admit that anything changed; customer made many changes since the solution was deployed; customer is unaware that a vendor support person replaced a piece of failed hardware with hardware that does not match the firmware that the solution supports; and user has done nothing, a new patch has been released but it was not added because it causes other problems to arise (new features, bug fixes, etc.).

It is clear that getting the right answers in a timely and efficient manner is critical to isolating problems in a complex solution. A key element in the discussion is whether the problem is software or hardware related. Information technology is not an evolving species. Software does not change itself (it generally is not intelligent enough to do so). Typically, problems are caused by (1) hardware failure; (2) operator error which changes the environment of the software; an/or (3) application failure which changes the environment of the software. Operator errors which can change the environment of software include, for example, deleting a file, forgetting to reboot for a particular change to take effect, introducing a virus, typos, and adding a patch without testing. Application failures which can change the environment of software include, for example, configuration errors, external event failures, and application bugs. Examples of environmental issues which can cause downtime are: an operating system patch was added to fix another problem and in fact caused the application software to not work properly; malformed configuration file; bad hardware; hardware was replaced with wrong firmware level; security settings were changed incorrectly; a disk is at 100% capacity; a dependent process is not running correctly, and a required application file is missing or corrupt.

Information technology watchdogs indicate that 20% of downtime is caused by technology failure, 40% of downtime is caused by operator error, and 40% of downtime is caused by application error. Once downtime is in progress, there are two main components to resolving the problem. Eighty percent of the downtime is spent identifying the problem while the remaining twenty percent of the downtime is spent resolving the identified problem. Accordingly, there is a need to reduce the causes of downtime and/or the amount of time it takes to identify the cause of downtime in a reactive administrative model.

### SUMMARY OF THE INVENTION

The present invention provides a system and method which overcomes at least some of the above-noted problems of the related art. According to one embodiment of the present invention, a system for diagnosing an information technology environment comprises, in combination, a collector server which stores configuration and event information gathered from the information technology environment and formats the information into formatted data and a data warehouse in communication with the collector server and housing formatted data imported from the collection server. A portal server is in communication with the collector server and the data warehouse and has an interface from which the formatted data in the data warehouse can be viewed.

According to another embodiment of the present invention, a system for diagnosing an information technology environment comprises, in combination, a collector server which stores information gathered from the information technology environment and formats the information into formatted data and a data warehouse in communication with the collector server and housing formatted data imported from the collection server. The collector server is located at a user site while the data warehouse and portal server are located at a provider site remote from the user site. A portal server is in communication with the collector server and the data warehouse and has an interface from which the formatted data in the data warehouse can be viewed.

According to another embodiment of the present invention, a system for diagnosing an information technology environment comprises, in combination, a collector server which stores information gathered from the information technology environment and formats the information into formatted data and a data warehouse in communication with the collector server and housing formatted data imported from the collection server. The collector server, the data warehouse, and the portal server are located at a user site. A portal server is in communication with the collector server and the data warehouse and has an interface from which the formatted data in the data warehouse can be viewed.

From the foregoing disclosure and the following more detailed description of various preferred embodiments it will be apparent to those skilled in the art that the present invention provides a significant advance in the technology and art systems and methods of identifying and mitigating information technology problems. Particularly significant in this regard is the potential the invention affords for providing a highly secure, high quality, reliable system and method. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a diagrammatic view of a CDR system according to a first embodiment of the present invention;

FIG. 2 is a diagrammatic view of a CDR module of the system of FIG. 1;

FIG. 3 is diagrammatic view of output of a file fingerprinting method;

FIG. 4 is a block diagram of a CDR method according to the present invention; and

FIG. 5 is a diagrammatic view of a CDR system according to a second embodiment of the present invention.

It should be understood that the appended drawings are not necessarily to scale, presenting a somewhat simplified representation of various preferred features illustrative of the basic principles of the invention. The specific design features of the information technology system as disclosed herein will be determined in part by the particular intended application and use environment.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved information technology system and method disclosed herein. The following detailed discussion of various alternative and preferred embodiments will illustrate the general principles of the invention with reference to a complex storage solution provider (but could be applied to any complex heterogeneous support scenario). Other embodiments suitable for other applications will be apparent to those skilled in the art given the benefit of this disclosure.

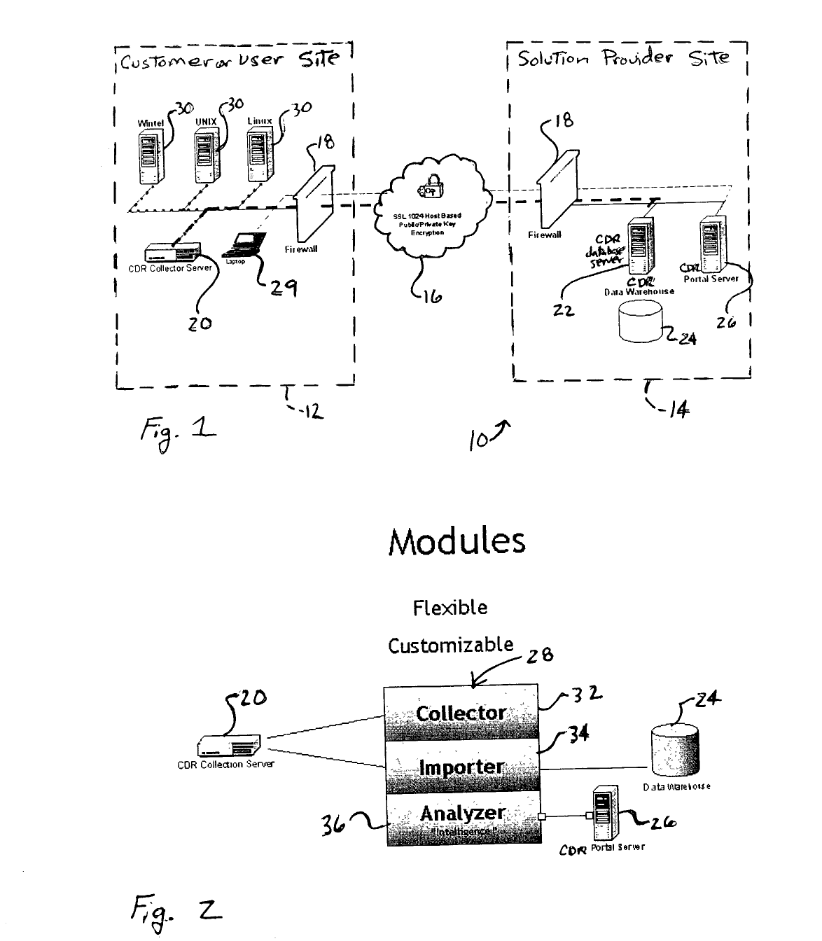

Referring now to the drawings, FIG. 1 shows a system 10 for Collecting, Diagnosing and Reporting (CDR) information about an information technology network or environment according to a preferred embodiment of the present invention. The CDR or diagnosing system 10 assists in identifying and mitigating problems related to software, hardware, application, or device configuration issues that cause downtime. The illustrated CDR system 10 includes components at a user or customer site and components at a solution provider site 14 which is remote from the customer site 12. While the illustrated CDR system 10 includes a single customer site 12, it is noted that a plurality of customer sites 12 can be utilized within the scope of the present invention. Networks at the illustrated sites 12, 14 are in communication via the Internet 16. It is noted, however, that other suitable communication connections can be utilized such as for example, an intranet or dial up connection. Each of the networks is preferably provided with a suitable firewall 18. The illustrated CDR system 10 includes at least one CDR collector server 20, a CDR database server 22 with a CDR database or data warehouse 24, a CDR portal server 26, at least one CDR module 28 (FIG. 2), and a computer or other suitable device 29, such as the illustrated laptop, for providing the user access to the system 10.

The CDR collector server 20 is provided at the customer site 12. While the illustrated CDR system 10 includes a single CDR collector server 20 provided at a single customer site 12, it is noted that there can be one or more customer sites 12 and thus more CDR collector servers 20. Preferably, there is a separate CDR collector server 20 at each customer site 12. The CDR collector server 20 is preferably an Intel-based system running a hardened version of the Linux operating system tailored for each unique customer. It is noted that the CDR collector server 20 can alternatively be based on any suitable processor and/or can alternatively run any suitable operating system. The CDR collector server 20 stores information gathered from the customer network, such as customer servers 30, as described in more detail hereinafter, regardless of which collection method is utilized. The CDR collector server 20 also preferably performs other functions or processes. In an auto upload process, all collected files or data are compressed and securely transmitted to the data warehouse 24 over the Internet 16. In an auto update process, the CDR collector server 20 securely connects to the CDR portal server 26 or CDR database server 22 over the Internet 16 to download new versions of the CDR module 28 or portions thereof, files or data, or server system settings. An auto health process preferably runs the CDR process on the CDR collection server 20 to better support the CDR collection serve 20. An auto clean-up process preferably cleans up old files on the CDR collection server 20 to prevent excessive storage and prevent things such as a full disk. With the auto clean-up process, the customer or user does not have to administer the CDR collection server 20. Preferably, the CDR collector server 20 is setup by the solutions provider with suitable security elements, such as public and private key based security, prior to shipment and installation at the customer site 12 in order to keep a highly secure mechanism for data transmission from the customer site 12 to the solution provider site 14. Configuring the security elements prior to shipment ensures that data will not be compromised with key exchanges via the Internet (which prevents the so called “man in the middle attack”). The CDR collector server 20 is preferably adapted to initiate all connections with components outside the customer site 12, that is outside the firewall 18. Thus, components at the provider site 14 or else where cannot initiate a connection with the CDR collector server 20.

The illustrated CDR database server 22 is located at the solution provider site 14. It is noted, however, that alternatively the CDR database server 22 can be located at the customer site 12 as described in more detail hereinafter. The CDR database server 22 can be based on any suitable processor and can run any suitable operating system. The CDR database server 22 imports data from the CDR collector server(s) 20 and preferably houses the data in relational database format and stores the data in the data warehouse 24. It is noted that the data can alternatively be housed and/or stored in other suitable formats if desired. Additionally, the CDR database server 22 can provide updates to the CDR collector server 20 whenever the CDR collector server 20 requests and update.

The term “portal” means a front-end interface or web interface which provides a communication channel, preferably a secure communication channel. The illustrated CDR portal server 26 is located at the solution provider site 14. It is noted, however, that alternatively the CDR portal server 26 can be located at the customer site 12 as discussed in more detail hereinafter or both sites. The CDR portal server 26 can be based on any suitable processor and can run any suitable operating system. The CDR portal server 26 provides a front-end interface to the data in the CDR database 24 utilizing a web browser interface, provides intelligence to the data, and provides updates to the CDR collector server 20 whenever the CDR collector server 20 requests an update.

As best shown in FIG. 2, the CDR module 28 is software made up of three elements: one or more collectors 32, an importer 34, and an analyzer 36. The collectors, which include one or more tools, are executable code which runs on the servers 30 and devices of the customer's system and gathers system, software, application, and device configuration, metric, and event information. This executable code gathers the configuration, metric and event information but preferably does not format the data. Output from the collectors 32 is a snapshot or blueprint. The snapshot is a point-in-time view of the system, software, application and device configuration and event information. The collector(s) 32 can be run at any time with limited overhead on the customer's system or device. A best practices approach is to execute the collector 32 just prior to making a change to the system and right after making the change to the system. Another approach is to automatically execute the collector 32 at regular intervals of time such as, for example, once every hour, once every twelve hours, once every twenty-four hours, once every seven days, or once every thirty days. The more frequently the collector 32 is executed, the more likely changes are going to be easily identified which give the user a better handle on the availability of its systems and/or devices. The importer 34 formats the data once the data has been transmitted to the CDR database server 22 (or the onsite data warehouse 24). The importer preferably cleans or formats the data and inserts the data into appropriate areas of appropriate databases so that the data can be viewed and manipulated by the web browser interface or application of the CDR portal server 26. Additionally, the intelligence of the importer provides the ability for proactive and reactive triggers. The analyzer 36 is the intelligence of the CDR system 10 and includes the web browser interface of the CDR portal server 26 and the intelligence behind it.

The CDR modules 28 are preferably written for every operating system, application and device/appliance connected to the customer's network. The CDR modules 28 can include collectors 32 customized for operating systems such as, for example, Solaris, Windows NT, Windows 2000, AIX, HP-UX, Linux, etc. The CDR modules 28 can include collectors 32 customized for applications such as, for example, VERITAS NetBackup, Oracle 9i RAC, PeopleSoft, custom applications, etc. The CDR modules 28 can include collectors 32 customized for devices/appliances such as, for example, Cisco routers/switches, firewalls, Brocade/McData fibre channel switches, tape library, NetApp Filer, Hitachi Lightning 99×0, EMC Symmetrix, etc.

The snapshot is an any-point-in-time collection of information for a server 30 regardless of collector type. For example, server “A” could have a collector for Solaris run at 4:00 am on Oct. 10, 2002 and run again at 10:45 am on Oct. 10, 2002. This would provide two independent snapshots of server “A” for Oct. 10, 2002.

Preferably, a snapshot is run once per day as documentation of that server 30 for that particular point in time. Of course, there are other benefits of having multiple snapshots of a single server 30 per day. For example, a snap shot can be run just prior to the installation of a piece of software or patch and one just after the update has been added. These two snapshots could then be compared to one another and allow the administrator to understand exactly what occurs if that particular piece of software is added to the customer's system.

The most beneficial use of the snapshot is targeted at decreasing downtime of the customer's system. With this approach, multiple snapshots of the system are taken on a regular basis. If at any point in time the system is not working or performing correctly, the administrator can compare the configuration between two snapshots, namely the point-in-time “X” when the system was functioning properly and the point-in-time “Y” when the system is behaving incorrectly. This comparison can identify very rapidly what has changed between those two points-in-time. Preferably, the user can identify and store a “gold image” or “master” snapshot. The gold image or master snapshot is a snapshot earmarked by an administrator as a known good system/device configuration, or any other snapshot which the administrator identifies as the gold image snapshot, to compare all future snapshots against. Preferably, there can only be one gold image snapshot per system or device at any one time. The gold image snapshot is never deleted unless a new snapshot is identified by the administrator as the “gold image” snapshot.

The collectors 32 can gather any information that can be obtained from the hardware and software, that is, the operating system, the applications, and the devices/appliances. The collectors 32 can be shell scripts, interpreted programs, compiled code, or anything else that can be run on the platform. The collected information preferably includes any and all information used to successfully document and fully support the end element (whether it is a system, operating system, application, or device/appliance). A preferred feature of the CDR system 10 is the ability to add any new commands, files for collection, and/or directories for collection which can happen dynamically on-the-fly.

For example, a collector 32 for Wintel can gather information including the following:

Version of Windows NT/Windows 2000;

System build number; Service pack revision level;

System uptime (when was the last system reboot); Environmental variables;

List of scheduled tasks;

Dump of the event log for application, security and system;

Copy of the critical boot files which allows later recovery capability in the event these files are disturbed;

Fingerprint (MD5 hash) of the following files (not inclusive, list includes):

Critical boot files;

%SYSTEMDRIVE%\NTLDR;

%SYSTEMDRIVE%\boot.ini;

%SYSTEMDRIVE%\bootsect.dos;

%SYSTEMDRIVE%\ntdetect.com;

%SYSTEMDRIVE%\hyberfile.sys;

%SYSTEMDRIVE%\ntbootdd.sys;

%SYSTEMDRIVE%\ntoskrnl.exe;

%SYSTEMDRIVE%\hal.dll;

Shared DLLs as indicated by the registry value:

HKLM\sftware\Microsoft\Windows\Current version\shareddlls

%SYSTEMDRIVE%\system32\*; and

%SYSTEMDRIVE%\system\*;

File system capacity information;

Current running processes;

Status of the last registry backup/dump; and

Backup of the entire registry which is essentially the entire static system configuration at the time of the backup (which is a point-in-time snapshot).

File collection is completely configurable, allowing for all or only a select few to be collected. It is noted that the data items listed are by way of example only and those skilled in the art will recognize that some items can be removed from the list and other items can be added to the list depending on the particular software and hardware under study.

Collectors 32 for Unix preferably have a significant amount of commonality. For example, a general overview of information gathered on UNIX platforms of Solaris, HP-UX, AIX, and Linux includes the following:

Host name;

Domain name;

Current date/time;

Host ID;

Kernel version;

Kernel settings and options;

List f last logins;

Network configuration settings;

Remote procedure call service settings;

Arp cache;

Current mount points;

Dmesg;

Lsmod List of kernel modules;

Depmod;

Ldconfig;

Crontab entries for the root user;

Ipcs;

Disk space information;

Memory usage;

Swap space usage;

Running processes;

Exhaustive file listing for:

/etc/rc?d;

/etc/cron; and

/etc/xinetd.d;

Who is currently logged in;

Listing of all installed packages (RPMs);

Local firewall configuration;

Lilo configuration;

Lspci and -vv;

Checkpc;

Lsof-b′

Gather a copy of the following files:

/var/log/syslog;

/var/adm/messages; and

any other files needed based on platform, OS, or application depending on the granularity desired;

Gather a copy of the following directories:

/etc; and

any other files needed based on platform, OS, or application depending on the granularity desired;

Fingerprint of the following files (default):

/etc;

/boot;

/lib/modules<kernel>; and

any other files needed based on platform, OS, or application depending on the granularity desired.

It is noted that the data items listed are by way of example only and those skilled in the art will recognize that some items can be removed from the list and other items can be added to the list depending on the particular software and hardware under study. For example, on a Linux server running firewall services, a user may want to include ALL files in a file system for security measures in order to determine if files have been tampered with. Also, for example, on a critical application server such as Oracle, a user may gather fingerprints on the oracle root directory which will include binaries and configuration files to determine when things change in the Oracle environment.

For example, a collector 32 for VERITAS NetBackup can gather information including the following:

Installation type: Master, media, Client;

License file;

Software registry key(s) information for VERITAS NetBackup configuration settings;

Software registry key(s) information for VERITAS NetBackup services settings;

Hardware registry key(s) information for storage hardware settings related to

NetBackup (SCSI, fibre channel, disk, tape, etc.); and

Data collection for Master:

Problems from the last 24 hours;

Media errors from the last 24 hours;

Backup status grouped by status code for the last 24 hours;

vmoprcmd—drive status;

bpclclients;

bpconfig;

bpgetconfig;

bpmedialist;

bpstulist;

bpcllist;

Essentially, ANY command provided by VERITAS to monitor the application;

The NetBackup files to generate reports on the performance of NetBackup (accessed by custom code); and

For the following log file types a directory is created if it does not exist (this enables that type of log):

admin;

bpcd;

bpdbjobs;

bpdbm;

bpjava-msvc;

bpjava-usvc;

bpinetd;

bprd;

bpsched;

bptm;

nbwin;

user_ops;

tar;

xpbadm; and

xpbmon.

It is noted that the data items listed are by way of example only and those skilled in the art will recognize that some items can be removed from the list and other items can be added to the list depending on the particular software and hardware under study. It is also noted that registry keys are used only in connection with Windows NT and Windows 2000 platforms but other like files are collected when the collector 32 for VERITAS NetBackup is used for other platforms such as UNIX platforms.

A system or device that does not have an open system operating system is considered to be a “non-intelligent” device. Examples of non-intelligent devices include Ethernet routers, switches, firewalls, NAS appliances, disk arrays, fibre channel switches, and tape libraries. Collectors for non-intelligent devices can operate in at least two different manners, each different from the collectors for intelligent devices. The first method is less secure by nature but is easier to implement. The first method uses the standard telnet interface of the device to logon to the device via TCP/IP over Ethernet and run command line tools to gather desired data. This is typically an interactive process but the process can be fully automated through tools such that a person does not need to interact with the interface to gather the configuration and event information for the device. The information collected can include:

Current running configuration;

Reboot configuration (the configuration which will be running if the system is rebooted);

Event history; and

Anything that can be obtained from the admin interface.

The second method is to utilize standard SNMP calls to obtain the data or use standards-based APIs to obtain the data.

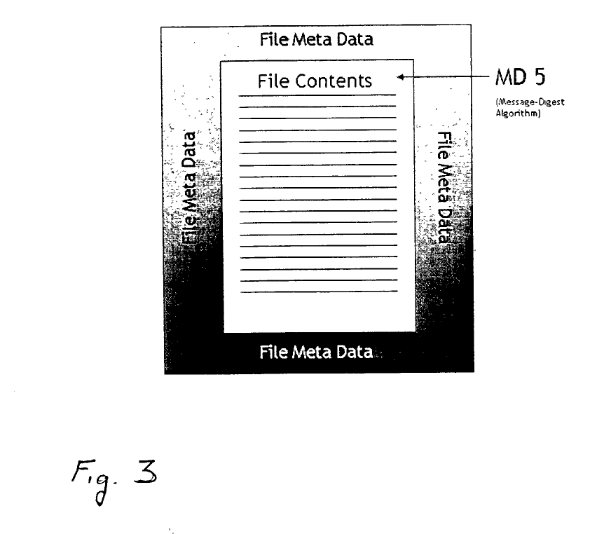

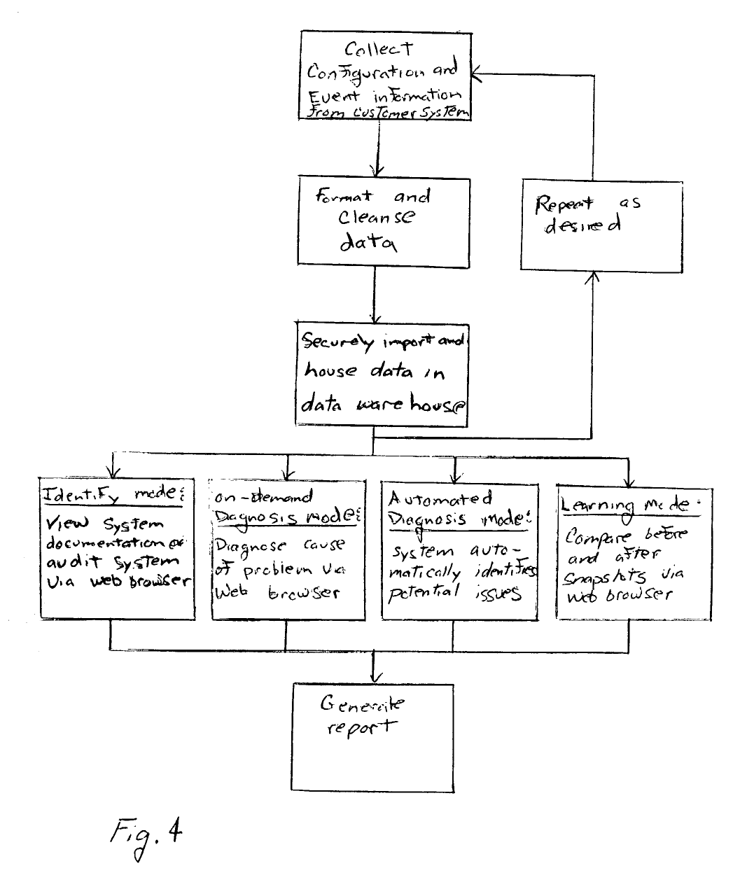

The CDR system 10 preferably includes a method for uniquely fingerprinting files in a file system. The purpose of fingerprinting files is to help rapidly identify the change of a file. FIG. 3 depicts the output of a suitable fingerprinting method. Given a file, a line of text is output providing unique details of the file. The unique details preferably include File Meta data that is information about the file (file properties). The File Meta data can include:

Filename;

File type;

Permissions;

File owner;

File group;

Size;

Number of blocks;

File inode;

File block size;

Last accessed;

Ctime; and

Last modified time.

The unique details also preferably include file contents. In addition to the collection of file meta data, the most unique portion is the actual file contents. The actual contents of the data are run against an MD5 Message-Digest Algorithm to generate a globally unique hash. Once this hash is computed, it can be compared over time to determine if the contents have changed. It is noted that the data items listed are by way of example only and those skilled in the art will recognize that some items can be removed from the list and other items can be added to the list depending on the particular software and hardware under study.

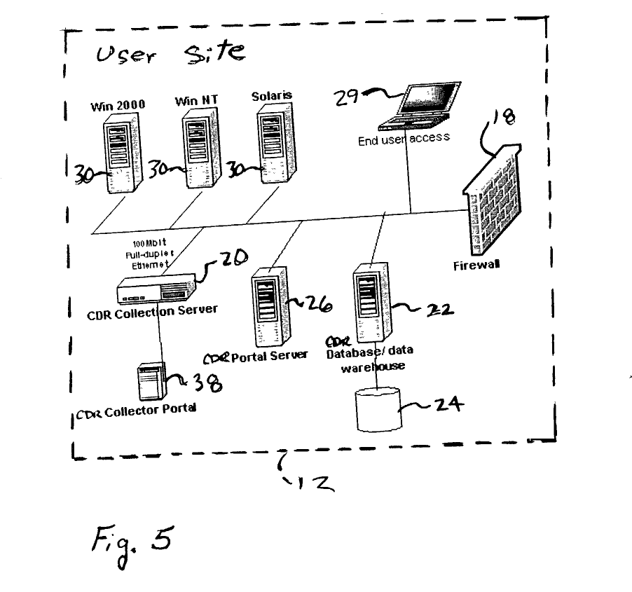

As best shown in FIG. 4, during operation of the CDR system 10 the first step of the CDR method is the collection process. During the collection step, the collectors 32 (the collection code) are run on the customer's servers 30. The collectors 32 gather desired configuration and event information or data. The gathered information is stored on the CDR collector server 20 at the customer site 12 rather than the customer's servers 30.

The collection process can be facilitated by any suitable method such as for example a CIFS/NFS method or an agent method. In the CIFS/NFS method, the systems administrator schedules job runs on the customer's server(s) 30 at particular times during the day. The scheduled job connects to the CDR collector server 20 using industry standard CIFS/NFS protocols to “mount” or “map” to the CDR directory where the collector code is located and runs the collector code for the appropriate platform of choice. The collector code is run directly from the CIFS/NFS share/map point and all output is sent directly to the CDR collection server 20 which essentially eliminates storage capacity issues on the customer's server(s) 30.

In the agent method, a small “service” is installed and configured to run automatically, or is configured to be run by an existing service which is automatically run at boot time on the customer server(s). The role of this service is to listen to a specific TCP/IP port for “interesting” data. This data is unique to the service, meaning the service will not respond if it is not using a known protocol. For example, the service will listen for a unique sequence of characters that starts a communication session. Once the session has initiated, the communication channel between the CDR collector server the customer's server will run the appropriate collection code to collect the desired data. Scheduling of all CDR processes can be handled completely through a local portal interface, thus jobs will no longer be required to be configured at the host layer. Additional functionality of the agent method includes the ability to no longer look at static information, the scheduler could run more frequently during the day to gather system state data, like performance information. This allows a combined effect of configuration, event and performance data that can all be overlaid to fully understand every aspect of system availability. The agent method is useful because it allows for secure, centralized and homogeneous scheduling process of all servers in the environment, it facilitates real time collection, and it is much more secure than the CIFS/NFS method.

Alternatively, an agent listing on a TCP/IP port is used with a secure communication protocol such as SSL or other industry accepted data encryption methodology. Scheduling of all CDR processes can be handled completely through a local portal interface, thus jobs will no longer be required to be configured at the host layer. This process is identical to the above process with the additional security mechanism in place so as to mitigate the snooping of the communication stream by a third party.

The second step of the CDR process is the importing process. Once the data has been collected, it must be cleansed and housed. The CDR collector server 20 will batch, potentially at the same time(s) daily or the CDR collector server 20 notices when new data arrives to automatically perform the importing process. The importing process preferably includes the following steps. First, the CDR collector server 20 preferably formats and cleanses the data. Next the formatted and cleansed data is housed in any one of a number of suitable methods. In one method, the CDR collector server 20 utilizes secure transport mechanisms to transmit compressed and encrypted meta data from the customer site 12 to the CDR database server 22 at the solution provider site 14 via the Internet 16. This can be accomplished using SSL 1024-bit public/private key encryption using any of the following encryption ciphers: AES, Blowfish, 3DES, DES, RSA1, RSA2, or other industry accepted cipher technologies. As best shown in FIG. 5, in an alternative embodiment, the data is entirely housed at the customer site 12. The CDR collection server 20, the portal server 26, and the database server 22 are each located at the customer site 12. Therefore, the entire system 10 is located within the user site 12 and information does not need to leave the user's network. The embodiment of FIG. 5 also includes a CDR collector portal 38 in communication with the at the CDR collector server 20. The CDR collector portal is located at the user site 12 with the CDR collector server 20. The CDR collector portal adds additional functionality by providing direct access to the collector server. With this direct access it is possible to, for example, schedule snapshots or obtain immediate uploads rather than wait for scheduled uploads. While the CDR collector portal 38 is illustrated with the embodiment of FIG. 5, it is noted that the collector portal can be utilized with other embodiments such as, for example, the embodiment illustrated in FIG. 1. These servers 20, 22, 26, 38 can be single or multi-tiered architectures based on the performance and data requirements that each unique customer needs, that is, all these components can exist on separate serves, the same server, or any combination thereof so that there are from one to four servers performing the functions.

During a regular interval or on request, the CDR collector server 20 via the update process will check for any update from the CDR portal server 26 or CDR database server 22. If a new version of a collector 32 or any other system component is available, the update process will download a copy of the new version of the collector 32 or any other system component for immediate or later installation. All communication is preferably initiated from the customer site 12, that is, at no point in time does a connection initiate from outside the customer's organization.

The third step of the CDR method is the analyzing process which includes steps of diagnosing and reporting the collected data. The roll of the analyzer 36 is to view the data and to use it in proactive and reactive methods to solve real business problems. The analyzer 36 is essentially the GUI front end provided by the CDR web portal and the intelligence behind it. Once the data has been collected and imported into the database, the user simply uses a ubiquitous web browser to securely log into the CDR portal via the Internet 16. All communications use the standard SSL encryption technology including the login and password. For additional security, a built-in timer can be provided which expires the current session based on inactivity or other predetermined event. The user, depending on his/her login credentials, has the capability of performing the following tasks through the portal: day-to-day administration; summary; view/compare; and reports.

For day-to-day administration, there is preferably an internal interface which is used by the solutions provider to administer the customer's databases and an external interface in which the end-users utilize to manage their specific environment. Internal administration tasks can include add new customers, add/change/delete users, set/reset user credentials, activate/deactivate profiles, request upload, and the like. External tasks can include adding users, changing users credentials, and the like.

The summary view of the portal interface preferably gives a customer a high-level view of all systems and devices collected in the environment. Therefore, using this view, the customer can easily see a summary of what configuration and event information has been collected.

The view/compare view of the portal interface preferably lists all servers 30 that are currently being monitored by the CDR collection system 10. In a single screen, the user preferably has the capability to do the following: click on a snapshot time and see the detailed configurations and logs; view the most current snapshot in one click; compare two distinct snapshots for a particular server to see how things have changed on that server 30; one-click compare the last two snapshots or the last snapshot to the “gold image” or “master” snapshot; and compare to different systems by selecting two distinct systems.

The diagnosing step can take at least for different forms: identify mode; on-demand diagnosis mode; automated diagnosis mode; and learning mode. In the identify mode, the user can identify, from the portal interface, system, hardware, software, application and/or device changes that affect availability, performance and usability. In addition, the identify mode could be used for on-demand documentation or audit purposes. The on-demand diagnosis mode is utilized when the system, hardware, software, application and/or device is not performing as it should and the customer needs to determine what is causing the problem. The customer logs onto the portal to determine what changes with the system, hardware, software, application, or device that has the problem. By doing a server compare, for example, a customer is able to quickly identify that the permissions of the backup services were changed to a user with the incorrect credentials causing the application to fail. In automated diagnosis mode, information is automatically sent to the customer (no human intervention) to help mitigate issues before they arise. The automated diagnosis can be proactive by highlighting best practices on the system such as application and device configuration and event settings. For example, Disk 0 is filling up and you need to keep it below 80% capacity, DLT8000 tape has a MTBF of 3000 passes and you have 2990 passes on cartridge 582 so you need to migrate this piece of media out of your pool of available media, or the /etc/st.conf file was changed on Sep. 12, 2002 at 9:14 am (it is now Sep. 13, 2002 11:45 am) but the machine was not rebooted so you need to reboot your server if you want these changes to take effect. The automated diagnosis can also be reactive by highlighting events that have already occurred. For example, Disk 0 is at 100%, backups on Server A, C and D failed last night due to a server communication error, or Server abc123 has not had a collection in 24 hours. In the learning mode, the user can compare before and after snapshots, from the portal interface, of a system to see exactly what changes occurred during a particular known event. For example, this comparison can allow the user to understand how a new application makes changes to their system if they were to run a collection just prior to installing a new application and collect again just after the installation of the application. Running a compare between these two snapshots would help in the learning process as to how applications and such impact the system.

The portal interface preferably permits a user to quickly report on all aspects of the system, hardware, software, application and/or devices. Standard reports can include monthly reports of change, proactive updates, and any other standard best practices reports. Custom reports can be tailored to each individual customer. Semi-annual (or other user defined timeframes) reports for management review can include a rollup of monthly reports. It is noted that proactive and reactive notifications or reports to the customer are preferably automatically generated by the automated diagnosis (no human intervention) discussed hereinabove.

From the foregoing disclosure and detailed description of certain embodiments of the present invention, it is apparent that the system provides a flexible architecture (1, 2, and 3 tier) and can be utilized in both a service provider model (where the CDR collector and the CDR collector portal reside at the customer site while the CDR data warehouse and CDR portal reside at the provider site) and a product model (where all components reside at the customer location). In the provider model, the system can “manage” itself from the standpoint of the user because the service provider provides all of the hardware maintenance. It is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A system for diagnosing an information technology environment comprises, in combination:
a collector server which stores configuration, metric and event information gathered from the information technology environment and formats the information into formatted data;
a data warehouse in communication with the collector server and housing formatted data imported from the collection server; and
a portal server in communication with the collector server and the data warehouse and having an interface from which the formatted data in the data warehouse can be viewed.

2. The system according to claim 1, wherein said collector server is located at a user site of the information technology environment.

3. The system according to claim 2, wherein said data warehouse is located at the user site.

4. The system according to claim 2, wherein said data warehouse is located at a provider site remote from the user site.

5. The system according to claim 4, wherein said data warehouse is in communication with the collector server via the Internet.

6. The system according to claim 2, wherein said portal server is located at the user site.

7. The system according to claim 2, wherein said portal server is located at a provider site remote from the user site.

8. The system according to claim 7, wherein said portal server is in communication with the collector server via the Internet.

9. The system according to claim 1, wherein said interface is a web portal accessible by a web browser.

10. The system according to claim 1, wherein said portal server is programmed to analyze the formatted data.

11. The system according to claim 1, wherein said portal server is programmed to provide and compare the formatted data from different collection times.

12. The system according to claim 1, wherein said portal server is programmed to provide proactive notices indicating conditions of the information technology environment.

13. The system according to claim 1, wherein data warehouse and said portal server are in communication with the portal server with secure communication.

14. The system according to claim 1, wherein said collector server is programmed to automatically download updates when connected to the portal server.

15. A system for diagnosing an information technology environment comprises, in combination:
a collector server which stores information gathered from the information technology environment and formats the information into formatted data;
wherein the collector server is located at a user site;
a data warehouse in communication with the collector server and housing formatted data imported from the collection server;
wherein the data warehouse is located at a provider site remote from the user site;
a portal server in communication with the collector server and the data warehouse and having an interface from which the formatted data in the data warehouse can be viewed; and
wherein said portal server is located at the provider site.

16. The system according to claim 15, wherein said information includes configuration, metric and event information.

17. The system according to claim 15, wherein said collector server is in communication with the data warehouse and the portal server via the Internet.

18. The system according to claim 15, wherein said interface is a web portal accessible by a web browser.

19. The system according to claim 15, wherein said portal server is programmed to analyze the formatted data.

20. The system according to claim 15, wherein said portal server is programmed to provide and compare the formatted data from different collection times.

21. The system according to claim 15, wherein said portal server is programmed to provide proactive notices indicating conditions of the information technology environment.

22. The system according to claim 15, wherein data warehouse and said portal server are in communication with the portal server with secure communication.

23. The system according to claim 15, wherein said collector server is programmed to automatically download updates when connected to the portal server.

24. A system for diagnosing an information technology environment comprises, in combination:
a collector server which stores information gathered from the information technology environment and formats the information into formatted data;
wherein the collector server is located at a user site;
a data warehouse in communication with the collector server and housing formatted data imported from the collection server;
wherein the data warehouse is located at the user site;
a portal server in communication with the collector server and the data warehouse and having an interface from which the formatted data in the data warehouse can be viewed; and
wherein said portal server is located at the user site.

25. The system according to claim 24, wherein said information includes configuration, metric and event information.

26. The system according to claim 24, wherein said interface is a web portal accessible by a web browser.

27. The system according to claim 24, wherein said portal server is adapted to analyze the formatted data.

28. The system according to claim 24, wherein said portal server is programmed to provide and compare the formatted data from different collection times.

29. The system according to claim 24, wherein said portal server is programmed to provide proactive notices indicating conditions of the information technology environment.

30. The system according to claim 24, wherein said collector server is programmed to automatically download updates when connected to the portal server.
